(19) United States
(12) Patent Application Publication
(10) Pub. No.: US 2013/0189432 A1
(43) Pub. Date: Jul. 25, 2013

(54) CARBON NANOTUBE PRODUCING APPARATUS AND CARBON NANOTUBE PRODUCING METHOD

(71) Applicant: Aisin Seiki Kabushiki Kaisha, Kariya-shi (JP)

(72) Inventor: Eiji NAKASHIMA, Obu-shi (JP)

(73) Assignee: Aisin Seiki Kabushiki Kaisha, Kariya-shi (JP)

(21) Appl. No.: 13/745,097

(22) Filed: Jan. 18, 2013

(30) Foreign Application Priority Data
Jan. 20, 2012 (JP) 2012-010225

(51) Int. Cl. C01B 31/02

(52) U.S. Cl. CPC C01B 31/0226
USPC 427/249.1; 118/715

(57) ABSTRACT

Provided is a carbon nanotube producing apparatus comprising a reaction chamber that accommodates a substrate that forms carbon nanotubes and reactive gas supply mechanism for supplying a reactive gas to the substrate accommodated in the reaction chamber, in which the reactive gas supply mechanism has two or more shower plates having a plurality of gas ejection holes, the shower plates being overlappingly arranged so that the reactive gas passes therethrough in order and the reactive gas is supplied to a carbon nanotube forming face of the substrate and the shower plates are arranged so that the ejection holes of the shower plates that are adjacent to each other do not overlap each other in a gas ejection direction.

### CROSS REFERENCE TO RELATED APPLICATIONS

This application is based on and claims priority under 35 U.S.C. §119 to Japanese Patent Application 2012-010225, filed on Jan. 20, 2012, the entire content of which is incorporated herein by reference.

### TECHNICAL FIELD

This disclosure relates to a carbon nanotube producing apparatus and a carbon nanotube producing method.

### BACKGROUND DISCUSSION

In a method and an apparatus for forming carbon nanotubes (CNT) disclosed in JP 2006-182640A (Reference 1), gas pressure within a reaction container is made lower than CNT forming gas pressure, and simultaneously, a catalyst forming substrate is heated to a predetermined temperature. Also, CNTs are generated by introducing hydrocarbon gas filled and enclosed in a filling portion into a reactor at one time, utilizing the difference between the gas pressure and the pressure of the gas within the reactor during CVD. This can reduce CNT in-plane variation. However, in this CVD process, the gas is introduced at one time, utilizing the difference between the pressure of the filling gas in an early stage of gas introduction and the internal pressure of the container. Thus, long CNT synthesis is impossible. Also, since gas introduction is achieved with a flow system, the gas does not reach the substrate efficiently, and thus, CNT cannot be synthesized in a high density. Additionally, since the gas cannot be continuously introduced at one time from a viewpoint of mass production, the above method and apparatus can not be applied.

In an apparatus and a method for producing oriented carbon nanotubes disclosed in International Publication No. WO08/096699 (Reference 2), a CVD reactive gas, a reducing gas, or the like is supplied from a shower head with a plurality of ejection holes to a substrate with a catalyst and thereby consumed without waste for CNT growth, so that oriented CNTs can be inexpensively mass-produced. However, although this method has a merit that CNTs can be inexpensively synthesized in large quantities by virtue of an efficient supply using the shower head structure, depending on a method to introduce gas to the shower head, bias occurs in gas supply rate (gas pressure) from a gas ejection portion, and CNT height variation occurs.

A need thus exists for a carbon nanotube producing apparatus and a method thereof which are not susceptible to the drawback mentioned above.

### SUMMARY

In order to solve the above-described problem, according to a first aspect of this disclosure, there is provided a carbon nanotube producing apparatus comprising: a reaction chamber that accommodates a substrate that forms carbon nanotubes; and reactive gas supply mechanism for supplying a reactive gas to the substrate accommodated in the reaction chamber, wherein the reactive gas supply mechanism has two or more shower plates having a plurality of gas ejection holes, the shower plates being overlappingly arranged so that the reactive gas passes therethrough in order and the reactive gas is supplied to a carbon nanotube forming face of the substrate, and wherein the shower plates are arranged so that the ejection holes of the shower plates that are adjacent to each other do not overlap each other in a gas ejection direction.

Additionally, according to a second aspect of this disclosure, there is provided a carbon nanotube producing method comprising: supplying a reactive gas to a substrate accommodated in a reaction chamber by reactive gas supply mechanism to form carbon nanotubes, wherein the reactive gas supply mechanism has two or more shower plates having a plurality of gas ejection holes, the shower plates being overlappingly arranged so that the reactive gas passes therethrough in order and the reactive gas is supplied to a carbon nanotube forming face of the substrate, and wherein the shower plates are arranged so that the ejection holes of the shower plates that are adjacent to each other do not overlap each other in a gas ejection direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration view of a carbon nanotube producing apparatus related to a first embodiment disclosed here;

FIGS. 2A and 2B are views illustrating a reactive gas introduction structure in the carbon nanotube producing apparatus disclosed here;

FIG. 3 is a view illustrating a reactive gas introduction structure in a carbon nanotube producing apparatus of the related art;

FIGS. 4A and 4B are views illustrating a reactive gas introduction structure to be used for a carbon nanotube producing apparatus related to a second embodiment;

FIGS. 5A and 5B are views illustrating a shower plate used in Example 1;

FIGS. 6A to 6C are views illustrating the simulation of the aspect of the flow of gas in a case where a reactive gas introduction structure of Example 1 is used;

FIG. 7 is a view showing the relationship between CNT height and gas pressure within a CNT plane of Example 1;

FIG. 8 is a view describing a shower plate used in Comparative Example 1;

FIGS. 9A and 9B are views illustrating the simulation of the aspect of the flow of gas in a case where a reactive gas introduction structure of Comparative Example 1 is used; and

FIG. 10 is a view showing the relationship between CNT height and gas pressure within a CNT plane of Comparative Example 1.

### DETAILED DESCRIPTION

Hereinafter, embodiments disclosed here will be explained with reference to the attached drawings.

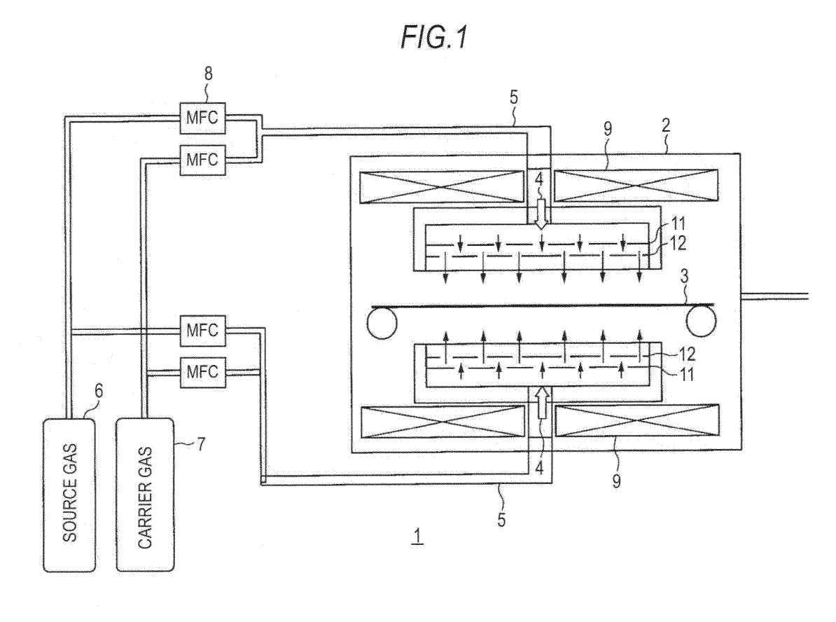

FIG. 1 shows a schematic configuration of a carbon nanotube producing apparatus 1 related to a first embodiment disclosed here.

A reaction chamber 2 can accommodate a substrate 3 for forming carbon nanotubes therein, and a gas introduction pipe 5 for introducing a reactive gas 4 for forming carbon nanotubes into the reaction chamber 2 is connected to the reaction chamber. The reactive gas 4 is supplied as a mixed gas obtained by mixing a source gas 6 for carbon nanotubes and a carrier gas 7 in a predetermined ratio by a flow rate controller 8 or the like. As shown in FIG. 1, the reactive gas 4 introduced into the reaction chamber 2 sequentially passes through a shower plate 11 and a shower plate 12 that have a plurality of gas ejection holes, respectively, and is supplied to the carbon nanotube forming face of the substrate 3 held at a predetermined position. In addition, in the configuration shown in FIG. 1, the reactive gas 4 can be similarly supplied to both faces of the substrate 3 so as to form carbon nanotubes on both the faces of the substrate. However, a configuration in which the reactive gas 4 is supplied only to one face of the substrate may be adopted.

The reaction chamber 2 is, for example, made of materials, such as SUS, and a reaction chamber of the structure in which air tightness is sufficiently taken can be used.

The substrate 3 to be used in the embodiment disclosed here is obtained by supplying the reactive gas 4 to the surface thereof and causing carbon nanotubes to grow, and a silicon substrate or a metal substrate can be used. Iron, titanium, copper, aluminum, iron alloys (including stainless steel), titanium alloys, copper alloys, aluminum alloys, or the like are illustrated as the metal. It is preferable that a catalyst given by vapor deposition, sputtering, dipping, or the like be present on the carbon nanotube forming face of the substrate 3, and transition metals are usually used as the catalyst. In particular, the metals of the V to VIII groups are preferable, and for example, iron, nickel, cobalt, titanium, platinum, palladium, rhodium, ruthenium, silver, gold, and alloys thereof are illustrated according to target values, such as the density of a carbon nanotube assembly to be formed. The catalyst is preferably an alloy of an A-B type, A is preferably at least one kind of iron, cobalt, and nickel, and B is preferably at least one kind of titanium, vanadium, zirconium, niobium, hafnium, and tantalum. In this case, the alloys preferably include at least one kind among an iron-titanium alloy and an iron-vanadium alloy. Moreover, the alloys may include a cobalt-titanium alloy, a cobalt-vanadium alloy, a nickel-titanium alloy, a nickel-vanadium alloy, and an iron-niobium alloy. In the case of the iron-titanium alloy, the mass ratios of titanium being equal to or more than 10%, equal to or more than 30%, equal to or more than 50%, equal to or more than 70% (the balance is iron), and equal to or less than 90% are illustrated. In the case of the iron-vanadium alloy, the mass ratios of vanadium being equal to or more than 10%, equal to or more than 30%, equal to or more than 50%, equal to or more than 70% (the balance is iron), and equal to or less than 90% are illustrated.

In the substrate 3 shown in FIG. 1, carbon nanotubes are formed on both the faces of the substrate. However, substrates that have separate catalysts on both the faces as well as substrates having the same catalyst on both the faces can also be used. Additionally, carbon nanotubes may be formed only on one face.

The reactive gas 4 for forming carbon nanotubes is preferably a mixed gas obtained by mixing the source gas 6 for carbon nanotubes and the carrier gas 7 in a predetermined ratio.

As the source gas 6 for carbon nanotubes, aliphatic hydrocarbon, such as alkane, alkene, and alkyne, aliphatic compounds, such as alcohol and ether, aromatic compounds, such as aromatic hydrocarbon, and the like are illustrated as a carbon source for forming carbon nanotubes. As the alcoholic source gas, gases, such as methyl alcohol, ethyl alcohol, propanol, butanol, pentanol, and hexanol are illustrated. Additionally, as for the hydrocarbon source gas, methane gas, ethane gas, acetylene gas, propane gas, and the like are illustrated.

As the carrier gas 7, argon gas, nitrogen gas, and helium gas can be used.

As methods of supplying the reactive gas 4 to the carbon nanotube forming face of the substrate 3 and causing carbon nanotubes to grow, CVD methods (a heat CVD method, a plasma CVD, and a remote plasma CVD) using the alcoholic source gas or the hydrocarbon source gas as the carbon source that causes carbon nanotubes to be formed are illustrated. However, the process conditions of the methods are not particularly limited and conditions may be set according to a related-art method.

The carbon nanotube producing apparatus 1 disclosed here has heating means 9 for performing heating to a carbon nanotube formation reaction temperature (for example, about 400 to 1000° C., particularly 550 to 700° C.). The heating means 9 can be constituted by a lamp heater that emits near-infrared rays. In a case where the substrate 3 has conductivity and permeability like iron or iron alloys, the heating means 9 may adopt an induction-heating method that heats the substrate 3 through electromagnetic induction. In the case of the induction-heating method, the surface of the carbon nanotube forming face of the substrate 3 can be intensively heated prematurely by a skin effect.

In the carbon nanotube producing apparatus 1 disclosed here, as shown in FIG. 1, the reactive gas 4 introduced into the reaction chamber 2 sequentially passes through the shower plate 11 and the shower plate 12 that have a plurality of gas ejection holes, respectively, and is supplied to the carbon nanotube forming face of the substrate 3 held at a predetermined position. In this case, the shower plate 11 and the shower plate 12 are arranged so that the ejection holes thereof do not overlap each other in a gas ejection direction. Thereby, as compared to when the shower plate is one plate, the flow rate of gas to be supplied to the carbon nanotube forming face of the substrate 3 can be made uniform, the gas pressure on the substrate become uniform, and the in-plane variation of the grown carbon nanotubes is reduced, although the carbon nanotubes have high density.

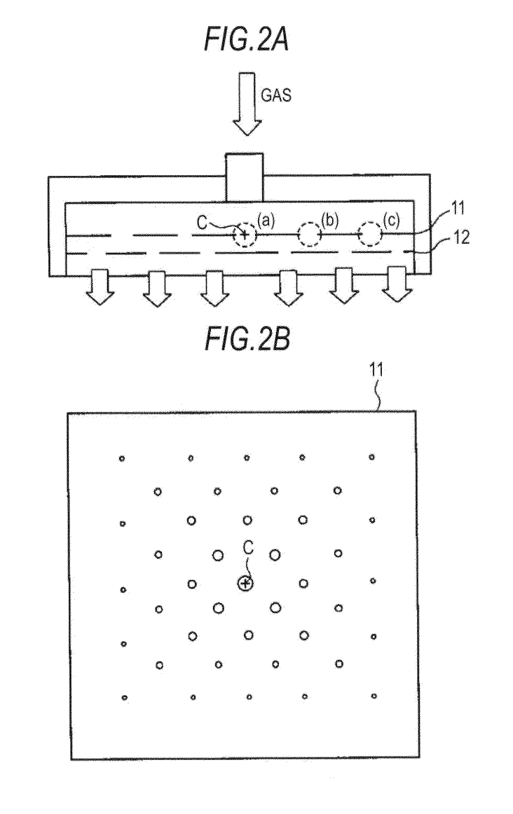

In the embodiment disclosed here, the gas flow rate can be made more uniform by making the size of the gas ejection holes of the shower plate 11 through which the reactive gas 4 passes first small as the distance from the position where the reactive gas 4 is introduced to the shower plate 11 to the gas ejection holes becomes larger. This provides, for example, a reactive gas introduction structure in which the sizes (a), (b), and (c) of the ejection holes are (a)>(b)>(c) and become small as being away from the center C in a case where the reactive gas 4 is introduced toward the center C of the shower plate 11 as shown in FIG. 2A, and thereby, ejection holes in which the size of the ejection holes is small as it goes to plate end portions from the vicinity of the center C as shown in plan view (FIG. 2B) of the shower plate 11 are arranged.

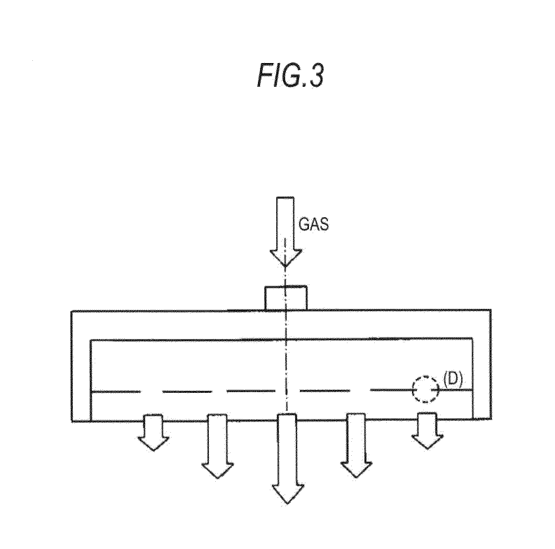

By adopting such a reactive gas introduction structure, the flow rate of gas to be supplied to the carbon nanotube forming face of the substrate can be made uniform, and carbon nanotubes can be made to grow in high-density while suppressing in-plane variation, whereas in the reactive gas introduction structure of the related art shown in FIG. 3, the gas flow rate becomes large at the center and the in-plane variation of carbon nanotubes formed in conjunction with this has occurred, because the size (D) of all of the gas ejection holes is the same and a single shower plate is used.

Although two shower plates are used in the above-described example, the shower plates used may be more than two. In that case, the shower plates are arranged so that the ejection holes of the shower plates that are adjacent to each other do not overlap each other in the gas ejection direction.

The shower plates to be used by the embodiment disclosed here may be those having a sufficient size in obtaining a predetermined film forming a maximum size, and the thickness of the shower plates is not also particularly limited, and can be, for example, a thickness of about 1 mm. As for the material of the shower plates, those made of SUS, or the like can be used in the case of single-face heating. However, in a case where a workpiece is heated by an infrared lamp heater in order to cause carbon nanotubes to grow on both faces of the substrate, it is preferable to use those made of quartz with light permeability. The size or number of the gas ejection holes of the shower plates can be made appropriate so that the desired carbon nanotubes can be formed. For example, the size can be about φ2 to 0.5 mm, and the number of holes can be about 2.4 pieces/cm². Additionally, the arrangement of the gas ejection holes of the shower plates can be an alternate arrangement.

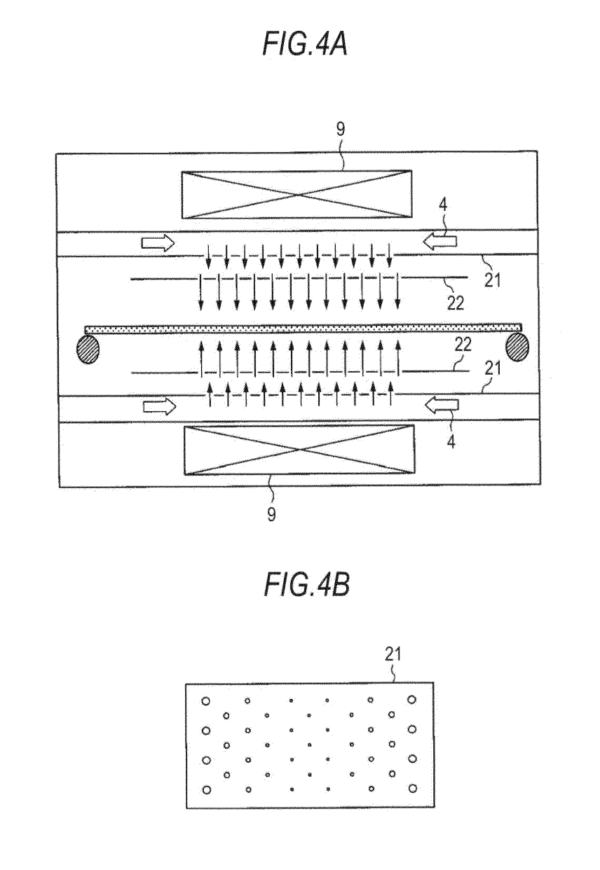

The outline of the inside of a reaction chamber 2 of a carbon nanotube producing apparatus related to a second embodiment disclosed here is shown in FIGS. 4A and 4B.

In the present embodiment, as shown in FIG. 4A, the reactive gas 4 is linearly introduced over the overall length of the right and left end of the shower plate 21 from the right and left ends toward a central direction, passes through a shower plate 21 and a shower plate 22 in that order, and is supplied to the carbon nanotube forming face of the substrate 3.

Similarly to the first embodiment, the size of the gas ejection holes of the shower plate 21 through which the reactive gas 4 passes first is made small as the distance from the position where the reactive gas 4 is introduced to the shower plate 21 to the gas ejection holes become larger, and as shown in the plan view (FIG. 4B) of the shower plate 21, the ejection holes in which the size of the ejection holes is small as it goes to the center perpendicularly from the right and left ends of the shower plate 21 are arranged. Hereinafter, the embodiment disclosed here will be more specifically described with examples and a comparative example.

### EXAMPLE 1

### Catalyst Substrate

As the substrate, a silicon substrate that has a square shape of 50 mm×50 mm and has a thickness of 0.5 mm was used. The silicon substrate was ground and the surface roughness Ra thereof was 5 nm.

After the silicon substrate was dipped in a treatment liquid in which hexaorganosilazane was blended in toluene in a concentration of 5 volume % for 30 minutes, the silicon substrate was pulled up and air-dried from the treatment liquid, and the surface thereof was subjected to hydrophobic treatment. Next, the catalyst substrate was obtained by coating a coating liquid on both faces of the silicon substrate, and forming a thin film of an iron-titanium alloy by 30 nm by a dip-coat method. The coating liquid was obtained by dispersing iron-titanium (Fe—Ti) alloy particles (Fe85%-Ti15% and an average particle diameter of 4.3 nm) in hexane and adjusting the concentration of the coating liquid so that absorbance becomes 0.35 on a measurement condition of a wavelength of 680 nm using a visible photometer (C07500 by WPA Inc.). In this case, if the coating of the coating liquid is performed by the dip-coat method, and the substrate was pulled up at a speed of 3 mm/min after dipping at a normal temperature in the atmosphere, hexane was evaporated rapidly by drying naturally. It is believed that the catalyst becomes island-like in the formed thin film.

### Reactive gas Introduction Structure

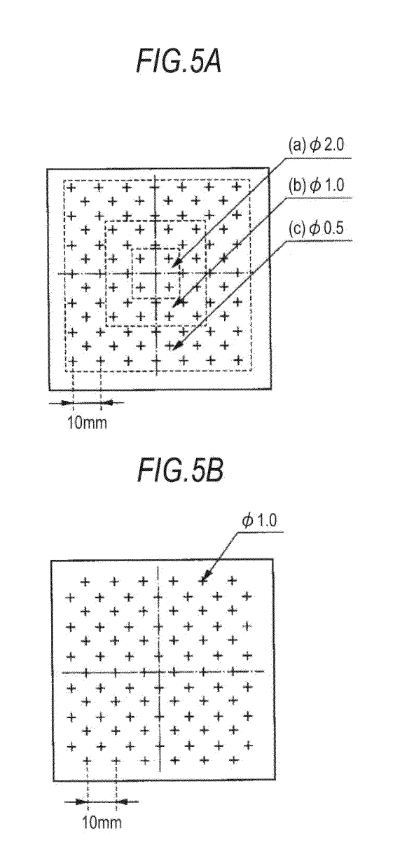

The reactive gas introduction structure shown in FIG. 2A was used, an upper plate shown in FIG. 5A was used as the upper shower plate 11, and a bottom plate shown in FIG. 5B was used as the lower shower plate 12. The upper plate is made of a SUS material that has a square shape of 60 mm×60 mm as a gas ejection face and has a thickness of 1 mm, and as shown in FIG. 5A, and has eighty five gas ejection holes in an alternate hole arrangement. In the upper plate, the size of the gas ejection holes becomes small as being away from the introduction position of the reactive gas, and among regions specified by three quadrangles shown by broken lines that become large as it goes to the outside from the center of FIG. 5A, the size of the gas ejection holes in the innermost region is φ2.0 mm, the size of the gas ejection holes in a region outside the innermost region is φ1.0 mm, and the size of the gas ejection holes in the outermost region is φ0.5 mm. The bottom plate, similarly to the upper plate, is made of a SUS material that has a square shape of 60 mm×60 mm as a gas ejection face and has a thickness of 1 mm, and as shown in FIG. 5B, has eighty four gas ejection holes in an alternate hole arrangement. The size of all the gas ejection holes of the lower plate is φ1.0 mm. The lower plate is arranged at a position apart from the substrate by 25 mm and the interval between the upper plate and the lower plate was 5 mm. As for the mutual positions of the gas ejection holes, the upper plate and the lower plate are overlapped with each other so that the centers thereof coincide with each other, and the gas ejection holes are alternately arranged so that the position of each gas ejection hole is located at the center of the distance between holes of the other plate in the arrangement of the gas ejection holes in the horizontal and vertical directions.

In the reactive gas introduction structure of Example 1, the size of the gas ejection holes of the upper shower plate becomes small as being toward the outside away from the center of the gas introduction position, and the reactive gas is uniformly dispersed. Additionally, the gas ejection holes of the upper and lower shower plates are adapted so as not to overlap each other, and the reactive gas is made more uniform.

An aspect of the flow of gas when this reactive gas introduction structure was used was obtained by simulation. Fluid simulation software “SCRYU/Tetra” was used as the simulation, and was carried out on the following conditions.

### Analysis Conditions

1. Analysis for steady state of gas

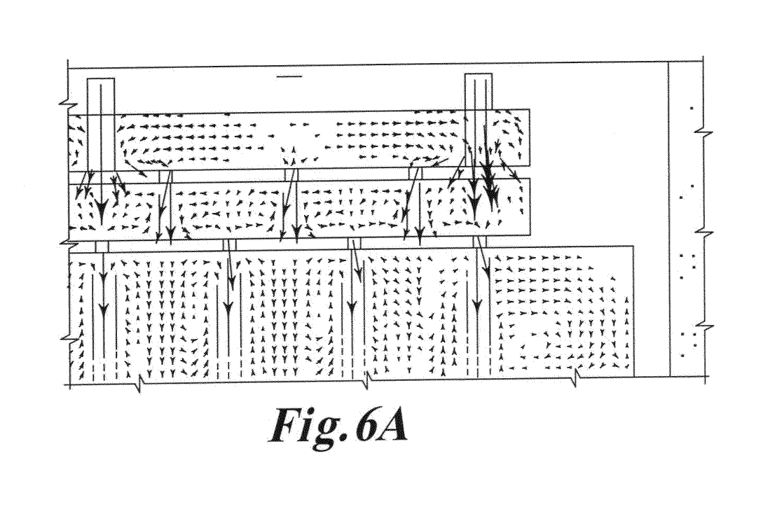

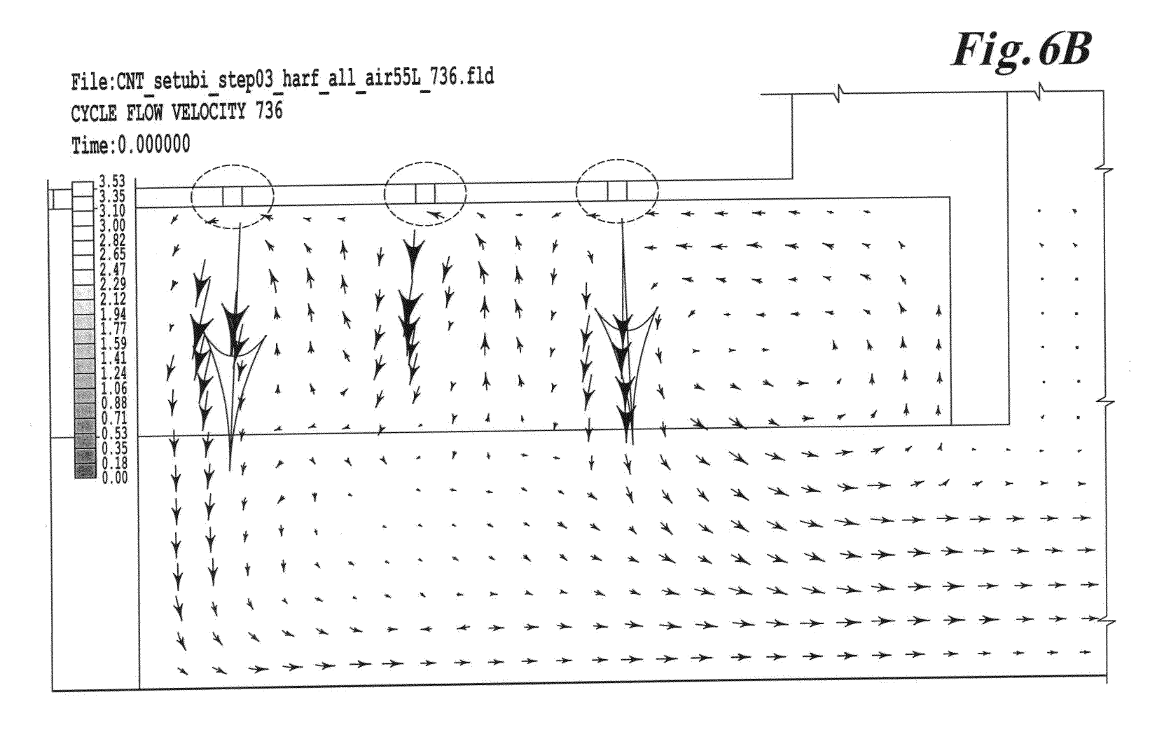

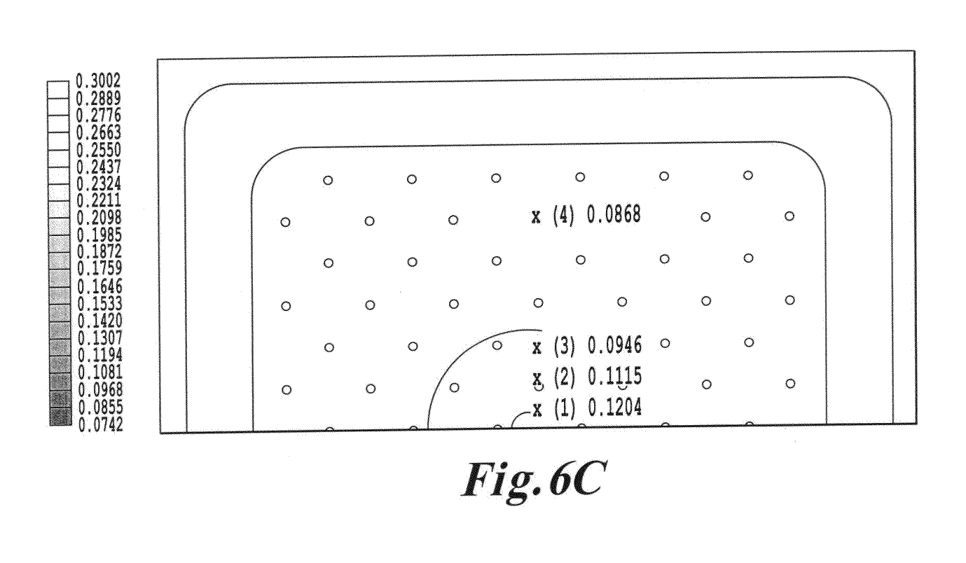

2. Analysis of flow in lower quarter space of shower head (FIG. 6A)

3. Calculation using air as gas (flow rate of CVD Condition: 5.5 L/min.).

### Boundary Conditions

(MAT1)
Name: air (uncompressed and 20° C.)
Kind: non-compressed fluid
Density: 1.205 (kg/m³)
Coefficient of viscosity: 1.03e-005 (Pa·s)
Specific heat at constant pressure: 1007 (J/(kg·K))
Heat conductivity: 0.0241 (W/(m·k))

### Analysis Patterns

Change gas physical properties: total of two patterns

Nitrogen+C2H2≅air (non-compressed air (20° C.))

### Analysis Type

Analysis for steady state

Turbulence (low Reynolds type)

Simulation results are shown in FIGS. 6B and 6C (FIGS. 6B and 6C show a gas flow rate vector and gas pressure on a workpiece set stage, respectively).

### CNT Forming Process

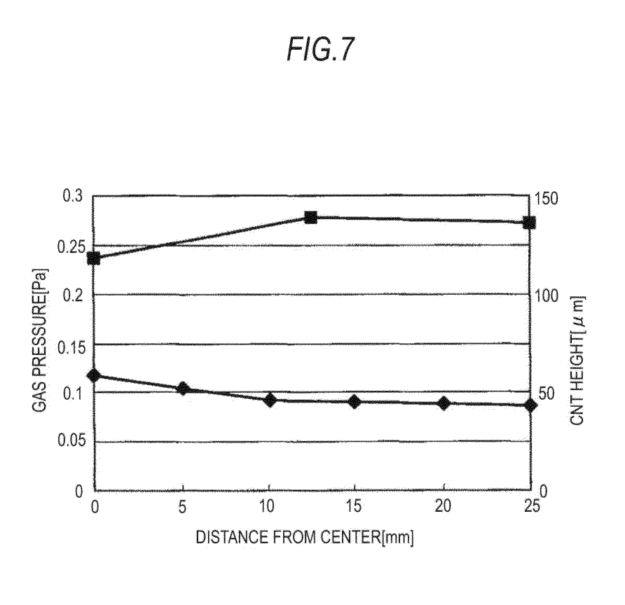

Carbon nanotubes were formed using the carbon nanotube producing apparatus by the heat CVD method configured in the same manner as FIG. 1. The substrate with a catalyst made above was set in the reaction chamber 2, was then covered, and was subjected to vacuuming up to 10 Pa. Nitrogen gas was introduced into the reaction chamber 2 at 5000 cc/min as the carrier gas 6, and the pressure was adjusted to 1×10⁵ Pa. Carbon nanotubes were formed by raising the substrate surface temperature to 600° C. for 5 minutes, and then, adding acetylene gas to the nitrogen gas, as the source gas 5 that becomes a carbon source, at 500 cc/min and introducing the acetylene gas for 6 minutes, thereby raising the substrate surface temperature to 650° C. As a result, the relationship between CNT height within a CNT plane and gas pressure brought a result as shown in FIG. 7, and the variation was suppressed to 20 μm even in a size of a 5 cm square. In addition, the “CNT height” in FIG. 7 was obtained by confirming the height of the carbon nanotubes formed using an SEM (apparatus: SU-70 made by Hitachi High Technologies Corporation, acceleration voltage: 5 kV, and magnification: x50 to x100). Additionally, the “gas pressure” was obtained from the above simulation results.

### Comparative Example 1

### Catalyst Substrate

The same catalyst substrate as Example 1 was used.

### Reactive gas Introduction Structure

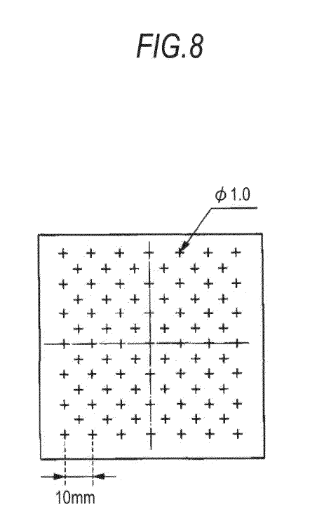

A reactive gas introduction structure shown in FIG. 3 was used, and one shower plate as shown in FIG. 8, which is made of a SUS material that has a square shape of 60 mm×60 mm as a gas ejection face and has a thickness of 1 mm, and has eighty five gas ejection holes of φ1.0 mm in an alternate hole arrangement, was used. This shower plate was arranged at a position apart from the substrate by 25 mm.

In the reactive gas introduction structure of Comparative Example 1, the shower plate is one plate and the size of a gas ejection hole is also the same. Thus, the flow velocity directly below a central gas introduction port is fast and thereby, the flow velocity becomes fast as being away toward the outside. As a result, supply of gas becomes non-uniform.

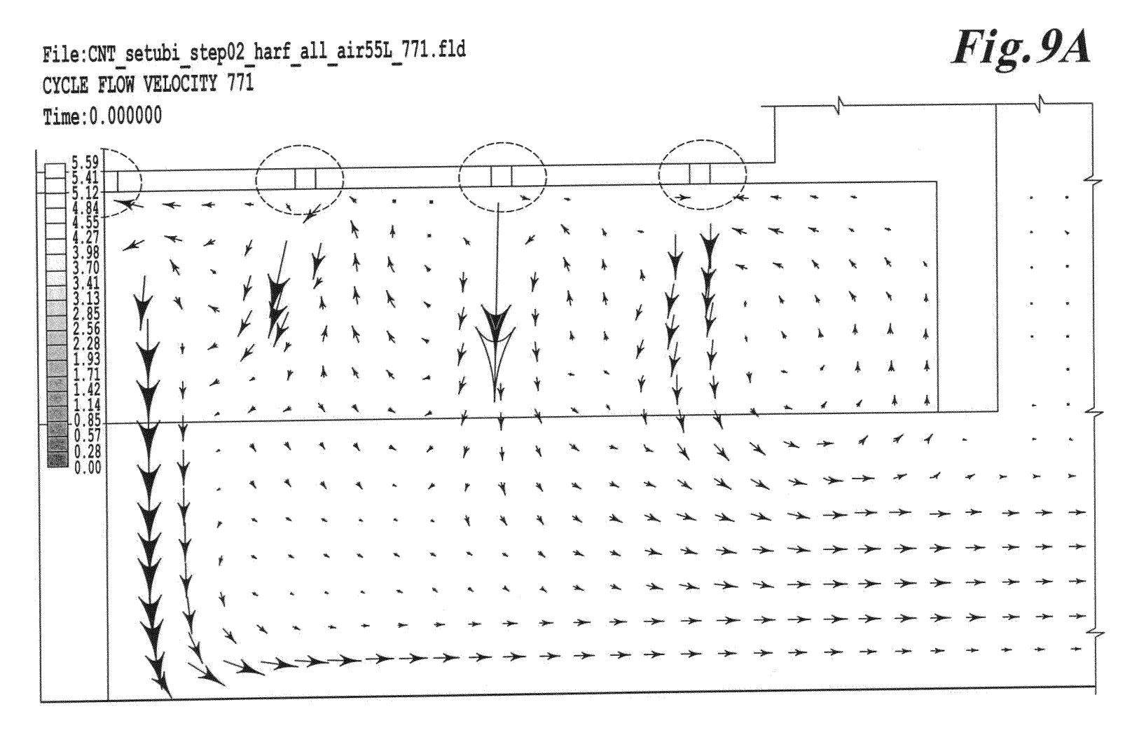

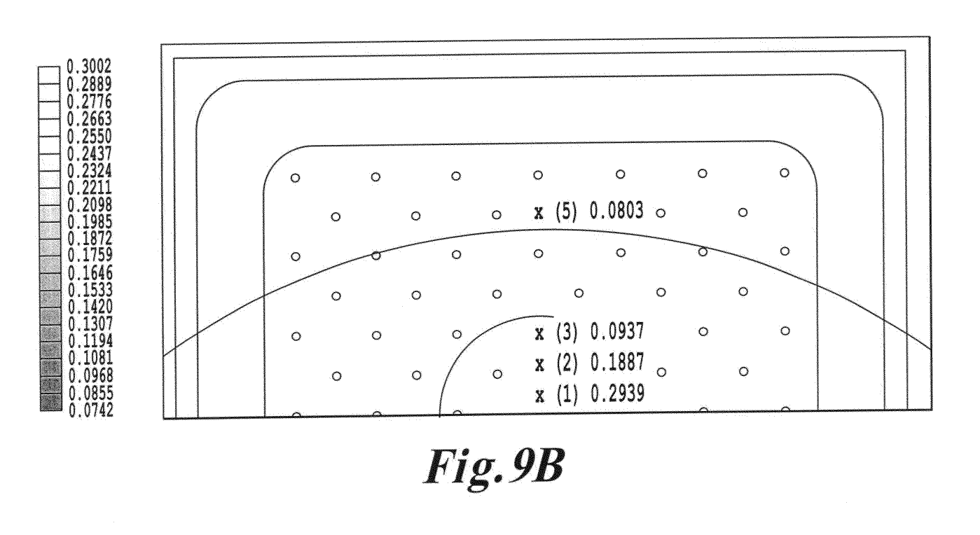

An aspect of the flow of gas when this reactive gas introduction structure was used was obtained by simulation, similarly to Example 1. Simulation results are shown in FIGS. 9A and 9B (FIGS. 9A and 9B show a gas flow rate vector and gas pressure on a workpiece set stage, respectively).

### CNT Forming Process

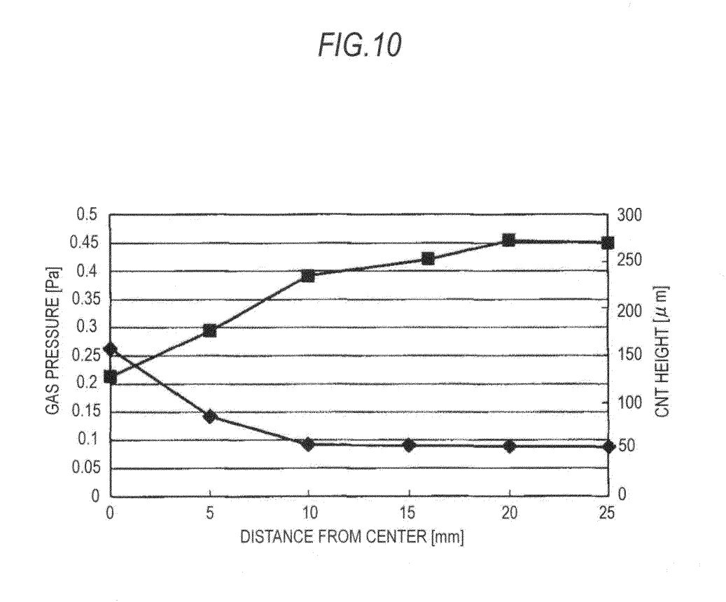

Carbon nanotubes were formed by the same conditions as those of Example 1. As a result, the relationship between CNT height within a CNT plane and gas pressure brought a result as shown in FIG. 10, and the variation of 240 μm occurred even in a size of a 5 cm square.

The gas pressure difference (Pa) and CNT height variation (μm) that were obtained from the results of the above Example 1 and Comparative Example 1 are shown in Table 1. As can be seen from these results, it turns out that those using the reactive gas introduction structure disclosed here are effective for the in-plane variation reduction of carbon nanotubes to be formed, as compared to the related art.

TABLE 1

| | Gas Pressure | CNT Height |
|---|---|---|
| | Difference [Pa] | Variation [μm] |
| Example 1 | 0.03 | 18 |
| Comparative Example 1 | 0.18 | 141 |

Therefore, aspects of this disclosure are described below. According to a first aspect of this disclosure, there is provided a carbon nanotube producing apparatus including a reaction chamber that accommodates a substrate that forms carbon nanotubes; and reactive gas supply mechanism for supplying a reactive gas to the substrate accommodated in the reaction chamber. The reactive gas supply mechanism has two or more shower plates having a plurality of gas ejection holes, the shower plates being overlappingly arranged so that the reactive gas passes therethrough in order and the reactive gas is supplied to a carbon nanotube forming face of the substrate, and the shower plates are arranged so that the ejection holes of the shower plates that are adjacent to each other do not overlap each other in a gas ejection direction.

Additionally, according to a second aspect of this disclosure, there is provided a carbon nanotube producing method including supplying a reactive gas to a substrate accommodated in a reaction chamber by reactive gas supply mechanism to form carbon nanotubes. The reactive gas supply mechanism has two or more shower plates having a plurality of gas ejection holes, the shower plates being overlappingly arranged so that the reactive gas passes therethrough in order and the reactive gas is supplied to a carbon nanotube forming face of the substrate, and the shower plates are arranged so that the ejection holes of the shower plates that are adjacent to each other do not overlap each other in a gas ejection direction.

According to the carbon nanotube producing apparatus and method of this disclosure, the gas flow rate from the shower gas ejection holes becomes uniform. Thus, the gas pressure on the CNT growth substrate becomes uniform, and carbon nanotubes can be formed on the substrate with uniform in-plane CNT height in a high density. In this way, the carbon nanotubes formed according to this disclosure have high density and uniform in-plane CNT height. Therefore, when the carbon nanotubes are used with electrodes of a structure in which perpendicularly orientated CNT are directly formed on a charge collector in applications as an electrode material of devices, such as a lithium ion capacitor and a lithium ion secondary cell, problems such as internal short-circuiting of a separator caused by thrusting and cell degradation caused by non-uniform current distribution inside the cell are solved, and improvement in reliability of products is achieved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A carbon nanotube producing apparatus comprising:
a reaction chamber that accommodates a substrate that forms carbon nanotubes; and
reactive gas supply mechanism for supplying a reactive gas to the substrate accommodated in the reaction chamber,
wherein the reactive gas supply mechanism has two or more shower plates having a plurality of gas ejection holes, the shower plates being overlappingly arranged so that the reactive gas passes therethrough in order and the reactive gas is supplied to a carbon nanotube forming face of the substrate, and
wherein the shower plates are arranged so that the ejection holes of the shower plates that are adjacent to each other do not overlap each other in a gas ejection direction.

2. The carbon nanotube producing apparatus according to claim 1,
wherein the size of the gas ejection holes of the shower plate through which the reactive gas passes first is made small as the distance from a position where the reactive gas is introduced to the shower plate to the gas ejection holes becomes large.

3. The carbon nanotube producing apparatus according to claim 1 or 2,
wherein the introduction position of the reactive gas is the center of the shower plate through which the reactive gas passes first.

4. The carbon nanotube producing apparatus according to claim 1 or 2,
wherein the introduction position of the reactive gas is an end of the shower plate through which the reactive gas passes first.

5. A carbon nanotube producing method comprising:
supplying a reactive gas to a substrate accommodated in a reaction chamber by reactive gas supply mechanism to form carbon nanotubes,
wherein the reactive gas supply mechanism has two or more shower plates having a plurality of gas ejection holes, the shower plates being overlappingly arranged so that the reactive gas passes therethrough in order and the reactive gas is supplied to a carbon nanotube forming face of the substrate, and
wherein the shower plates are arranged so that the ejection holes of the shower plates that are adjacent to each other do not overlap each other in a gas ejection direction
